(19) United States
(12) Patent Application Publication
(10) Pub. No.: US 2008/0118761 A1
(43) Pub. Date: May 22, 2008

(54) MODIFIED SOLDER ALLOYS FOR ELECTRICAL INTERCONNECTS, METHODS OF PRODUCTION AND USES THEREOF

(76) Inventors: Martin W. Weiser, Liberty Lake, WA (US); Jianxing Li, Spokane, WA (US)

Correspondence Address: BUCHALTER NEMER, 18400 VON KARMAN AVE., SUITE 800, IRVINE, CA, 92612, US

(21) Appl. No.: 11/853,556

(22) Filed: Sep. 11, 2007

Related U.S. Application Data
(60) Provisional application No. 60/844,445, filed on Sep. 13, 2006.

(51) Int. Cl. C22C 12/00; B32B 15/04

(52) U.S. Cl. 428/457; 420/577

(57) ABSTRACT

Lead-free solder compositions having a thermal conductivity are disclosed that include at least about 2% of silver, at least about 60% of bismuth, and at least one additional metal in an amount that will increase the thermal conductivity of the solder composition over a comparison solder composition consisting of silver and bismuth, wherein the at least one additional metal does not significantly modify the solidus temperature and does not shift the liquidus temperature outside of an acceptable liquidus temperature range. Methods of producing these lead-free solder compositions are also disclosed that include providing at least about 2% of silver, providing at least about 60% of bismuth, providing at least one additional metal in an amount that will increase the thermal conductivity of the solder composition over a comparison solder composition consisting of silver and bismuth, blending the bismuth with the at least one additional metal to form a bismuth-metal blend, and blending the bismuth-metal blend with copper to form the solder composition, wherein the at least one additional metal does not significantly modify the solidus temperature and does not shift the liquidus temperature outside of an acceptable liquidus temperature range. Additional methods of producing a lead-free solder composition having a thermal conductivity include providing at least about 2% of silver, providing at least about 60% of bismuth, providing at least one additional metal in an amount that will increase the thermal conductivity of the solder composition over a comparison solder composition consisting of silver and bismuth, blending the silver with the at least one additional metal to form a silver-metal alloy, and blending the silver-metal alloy with bismuth to form the solder composition, wherein the at least one additional metal does not significantly modify the solidus temperature and does not shift the liquidus temperature outside of an acceptable liquidus temperature range

This application is a United States Utility Application that claims priority to U.S. Provisional Application Ser. No. 60/844,445 filed on Sep. 13, 2006, which is incorporated herein by reference in its entirety.

### FIELD OF THE SUBJECT MATTER

The field of the subject matter is modified, lead-free thermal interconnect systems, thermal interface systems and interface materials in electronic components, semiconductor components and other related layered materials applications.

### BACKGROUND OF THE SUBJECT MATTER

Electronic components are used in ever increasing numbers of consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

Components, therefore, are being broken down and investigated to determine if there are better building and intermediate materials, machinery and methods that will allow them to be scaled down to accommodate the demands for smaller electronic components. Part of the process of determining if there are better building materials, machinery and methods is to investigate how the manufacturing equipment and methods of building and assembling the components operates.

Numerous known die attach methods utilize a high-lead solder, solder compositions or solder material to attach the semiconductor die within an integrated circuit to a leadframe for mechanical connection and to provide thermal and electrical conductivity between the die and leadframe. Although most high-lead solders are relatively inexpensive and exhibit various desirable physico-chemical properties, the use of lead in die attach and other solders has come under increased scrutiny from an environmental and occupational health perspective. Consequently, various approaches have been undertaken to replace lead-containing solders with lead-free die attach compositions.

For example, in one approach, polymeric adhesives (e.g., epoxy resins or cyanate ester resins) are utilized to attach a die to a substrate as described in U.S. Pat. Nos. 5,150,195; 5,195,299; 5,250,600; 5,399,907 and 5,386,000. Polymeric adhesives typically cure within a relatively short time at temperatures generally below 200° C., and may even retain structural flexibility after curing to allow die attach of integrated circuits onto flexible substrates as shown in U.S. Pat. No. 5,612,403. However, many polymeric adhesives tend to produce resin bleed, potentially leading to undesirable reduction of electrical contact of the die with the substrate, or even partial or total detachment of the die.

To circumvent at least some of the problems with resin bleed, silicone-containing die attach adhesives may be utilized as described in U.S. Pat. No. 5,982,041 to Mitani et al. While such adhesives tend to improve the bonding between the resin sealant and the semiconductor chip, substrate, package, and/or lead frame, the curing process for at least some of such adhesives requires a source of high-energy radiation, which may add significant cost to the die attach process.

Alternatively, a glass paste comprising a high-lead borosilicate glass may be utilized as described in U.S. Pat. No. 4,459,166 to Dietz et al., thereby generally avoiding a high-energy curing step. However, many glass pastes comprising a high-lead borosilicate glass require temperatures of 425° C. and higher to permanently bond the die to the substrate. Moreover, glass pastes frequently tend to crystallize during heating and cooling, thereby reducing the adhesive qualities of the bonding layer.

In yet another approach, various high melting solders are utilized to attach a die to a substrate or leadframe. Soldering a die to a substrate has various advantages, including relatively simple processing, solvent-free application, and in some instances relatively low cost. There are various high melting solders known in the art. However, all or almost all of them have one or more disadvantages. For example, most gold eutectic alloys (e.g., Au-20% Sn, Au-3% Si, Au-12% Ge, and Au-25% Sb) are relatively costly and frequently suffer from less-than-ideal mechanical properties. Alternatively, Alloy J (Ag-10% Sb-65% Sn, see e.g., U.S. Pat. No. 4,170,472 to Olsen et al.) may be used in various high melting solder applications. However, Alloy J has a solidus of 228° C. and also suffers from relatively poor mechanical performance.

For those components that require electronic interconnects, spheres, balls, powder, preforms or some other solder-based component that can provide an electrical interconnect between two components are utilized. In the case of BGA spheres, the spheres form the electrical interconnect between a package and a printed circuit board and/or the electrical interconnection between a semiconductor die and package or board. The locations where the spheres contact the board, package or die are called bond pads. The interaction of the bond pad metallurgy with the sphere during solder reflow can determine the quality of the joint, and little interaction or reaction will lead to a joint that fails easily at the bond pad. Too much reaction or interaction of the bond pad metallurgy can lead to the same problem through excessive formation of brittle intermetallics or undesirable products resulting from the formation of intermetallics.

There are several approaches to correct and/or reduce some of the solder problems presented herein. For example, Japanese patent, JP07195189A, uses bismuth, copper and antimony simultaneously as dopants in a BGA sphere to improve joint integrity. Phosphorous may or may not be added; however, results in this patent show that phosphorus additions performed poorly. Phosphorus was added in high weight percentages, as compared to other components. Levels of copper ranged from 100 ppm to 1000 ppm.

In “Effect of Cu Concentration on the reactions between Sn—Ag—Cu Solders and Ni”, Journal of Electronic Materials, Vol. 31, No 6, p 584, 2002 by C. E. Ho, et. al, and Republic of China Patent 149096I (Mar. 23, 2001); C. R. Kao and C. E Ho, the effect of copper additions on improving Sn—Pb eutectic performance on ENIG bond pads is investigated. Compositions comprising less than 2000 ppm Cu were not investigated.

Jeon, et. al, “Studies of Electroless Nickel Under Bump Metallurgy—Solder Interfacial Reactions and Their Effects on Flip Chip Joint Reliability”, Journal of Electronic Materials, pg 520-528, Vol 31, No 5, 2002, and Jeon et.al, “Comparison of Interfacial Reactions and Reliabilities of Sn3.5Ag and Sn4.0Ag0.5Cu and Sn0.7Cu Solder Bumps on Electroless Ni—P UBMs” Proceeding of Electronic Components and Technology Conference, IEEE, pg 1203, 2003 discuss that intermetallic growth is faster on pure nickel bond pads than electroless nickel bonds pads. The benefits of copper in concentrations of 0.5% (5000 ppm) or higher are also investigated and discussed in both articles.

Zhang, et.al, “Effects of Substrate Metallization on Solder/UnderBump Metallization Interfacial Reactions in Flip-Chip Packages during Multiple Reflow Cycles”, Journal of Electronic Materials, Vol 32, No 3, pg 123-130, 2003 shows there is no effect from phosphorus on slowing intermetallic consumption (which contradicts the Jeon article). Shing Yeh, “Copper Doped Eutectic Tin-Lead Bump for Power Flip Chip Applications”, Proceeding of Electronic Components and Technology Conference, IEEE, pg 338, 2003 notes that a 1% copper addition reduced nickel layer consumption.

The Niedrich patents and application (EP0400363 A1 EP0400363B1 and U.S. Pat. No. 5,011,658) show copper used as a dopant in Sn—Pb—In solders to minimize the consumption of copper bond pads or connectors (i.e., no nickel barrier layer is used). The copper in the solder was found to decrease the copper connector dissolution. Niedrich uses the copper to inhibit nickel barrier layer interaction through forming copper intermetallics or (Cu, Ni)Sn intermetallics. The Niedrich patents are very similar in their use of copper as U.S. Pat. No. 2,671,844, which adds copper to solder in amounts greater than 0.5 wt % to minimize dissolution of copper soldering iron tips during fine soldering operations.

The US Issued U.S. Pat. No. 4,938,924 by Ozaki noted that the addition of 2000-4000 ppm of copper improves wetting and long term joint reliability of in Sn—36Pb—2Ag alloys Japanese Patent JP60166191A “Solder Alloy Having Excellent Resistance to Fatigue Characteristic” discloses a Sn Bi Pb alloy with 300-5000 ppm copper added to improve fatigue resistance.

US Issued U.S. Pat. No. 6,307,160 teaches the use of at least 2% indium to improve the bond strength of the eutectic Sn—Pb alloy on Electroless Nickel/Immersion Gold (ENIG) bond pads.

US Issued U.S. Pat. No. 4,695,428 “Solder Composition” discloses a Pb-free solder composition used for plumbing joints. The copper concentration used is in excess of 1000 ppm and several other elements are also added as alloying additions to improve the liquidus, solidus, flow properties and surface finish of the solder.

In bismuth-based solders, the thermal conductivity is quite low due to the low thermal conductivity of bismuth. These solders exhibit failure during thermal cycling along the interface due to nickel metallization (plated or sputtered) which interacts/reacts with the solder.

Thus, there is a continuing need to: a) develop lead-free modified solder materials that function in a similar manner as lead-based or lead-containing solder materials; b) develop modified solder materials that have no deleterious effects on bulk solder properties, yet slows the consumption of the nickel-barrier layer and hence, in some cases, growth of a phosphorus-rich layer, so that bond integrity is maintained during reflow and post reflow thermal aging; c) design and produce electrical interconnects that meet customer specifications while minimizing the production costs and maximizing the quality of the product incorporating the electrical interconnects; d) develop reliable methods of producing electrical interconnects and components comprising those interconnects, and e) develop solder materials and compositions that have increased thermal conductivity without a practically significant change in the solder's liquidus and solidus temperatures/temperature ranges, while in some embodiments improving the ductility of the material.

### BRIEF DESCRIPTION OF THE FIGURES & TABLES

FIG. 1 shows an Ag—Bi phase diagram.

FIG. 2 shows an electron micrograph, in which the Ag—Bi alloy appears to form a hypoeutectic alloy wherein the primary constituent (silver) is surrounded by fine eutectic structure.

FIG. 3 shows a phase diagram containing silver, bismuth and copper.

FIG. 4 shows the DTA (differential thermal analysis) curve at 20° C./min for the Bi10Ag10Cu—Ge solder alloy in Table 1.

FIG. 5 shows the DSC (differential scanning calorimetry) data at 20° C./min for the two new solder alloys shown in Table 1.

FIG. 6 shows the main effects plot for thermal conductivity.

FIG. 7 shows DTA data for contemplated solder alloys.

FIG. 8 shows DTA data for contemplated solder alloys.

FIG. 9 shows DTA data for contemplated solder alloys.

FIG. 10 shows wire ductility results utilizing several solder alloys.

FIG. 11 shows thermal conductivity analysis for some of the contemplated alloys using a laser flash method indicated thermal conductivity of at least 9 W/m K.

FIG. 12 shows contemplated compositions (and materials comprising contemplated compositions) may be utilized in an electronic device to bond a semi-conductor die (e.g., silicon, germanium, or gallium arsenide die) to a leadframe.

Table 1 shows melting and thermal conductivity results for various contemplated solders with at least one additional metal added, as compared with bismuth and antimony individually.

Table 2 shows another group of contemplated solder alloys and their thermal data.

Table 3 shows wire ductility results utilizing several solder alloys.

### SUMMARY OF THE SUBJECT MATTER

Lead-free solder compositions having a thermal conductivity are disclosed that include at least about 2% of silvers at least about 60% of bismuth, and at least one additional metal in an amount that will increase the thermal conductivity of the solder composition over a comparison solder composition consisting of silver and bismuth, wherein the at least one additional metal does not significantly modify the solidus temperature and does not shift the liquidus temperature outside of an acceptable liquidus temperature range

Methods of producing these lead-free solder compositions are also disclosed that include providing at least about 2% of silver, providing at least about 60% of bismuth, providing at least one additional metal in an amount that will increase the thermal conductivity of the solder composition over a comparison solder composition consisting of silver and bismuth, blending the bismuth with the at least one additional metal to form a bismuth-metal blend, and blending the bismuth-metal blend with copper to form the solder composition, wherein the at least one additional metal does not significantly modify the solidus temperature and does not shift the liquidus temperature outside of an acceptable liquidus temperature range.

Additional methods of producing a lead-free solder composition having a thermal conductivity include providing at least about 2% of silver, providing at least about 60% of bismuth, providing at least one additional metal in an amount that will increase the thermal conductivity of the solder composition over a comparison solder composition consisting of silver and bismuth, blending the silver with the at least one additional metal to form a silver-metal alloy, and blending the silver-metal alloy with bismuth to form the solder composition, wherein the at least one additional metal does not significantly modify the solidus temperature and does not shift the liquidus temperature outside of an acceptable liquidus temperature range

### DESCRIPTION OF THE SUBJECT MATTER

Unlike the previously described references, modified solder materials are described herein that are lead free and that function in a similar manner as lead-based or lead-containing solder materials; that have no deleterious effects on bulk solder properties, yet slow the consumption of the nickel-barrier layer, so that bond integrity is maintained during reflow and post reflow thermal aging. These modified solders meet the goals of a) designing and producing electrical interconnects that meet customer specifications while minimizing the production costs and maximizing the quality of the product incorporating the electrical interconnects; b) developing reliable methods of producing electrical interconnects and components comprising those interconnects, and c) developing solder materials and compositions that have increased thermal conductivity without a practically significant change in the solder's liquidus and solidus temperatures/temperature ranges, while in some embodiments improving the ductility of the material.

Lead free solder compositions comprising bismuth and silver are described herein that also include at least one additional metal, wherein the additional metal has a high thermal conductivity and will increase the thermal conductivity of the solder. In addition, modified solders contemplated herein are substantially lead free. These solders are also considered to be at least ternary alloys. Specifically, lead-free solder compositions having a thermal conductivity are disclosed that include at least about 2% of silver, at least about 60% of bismuth, and at least one additional metal in an amount that will increase the thermal conductivity of the solder composition over a comparison solder composition consisting of silver and bismuth, wherein the at least one additional metal does not significantly modify the solidus temperature and does not shift the liquidus temperature outside of an acceptable liquidus temperature range. As mentioned, contemplated solder materials and compositions have increased thermal conductivity without a practically significant change in the solder's liquidus and solidus temperatures/temperature ranges, while in some embodiments improving the ductility of the material. As used herein, the phrase “practically significant change” means that the change may be statistically significant, but the change will not adversely affect the use of the solder compositions, as contemplated.

As used herein, one of ordinary skill in the art of solder materials and compositions should understand the phrase “acceptable liquidus temperature range” to mean a change or shift in the liquidus range that permits or allows the solder alloy to be substantially liquid with only a small amount or percentage of solid at the soldering temperature. This acceptable range may be a few degrees for some solders and solder alloys, is typically 10-20 degrees for many solders and solder alloys, but may be 100-400 degrees for other solders. The benchmark for this acceptable liquidus temperature range is that the solder alloy is still substantially liquid within that temperature range.

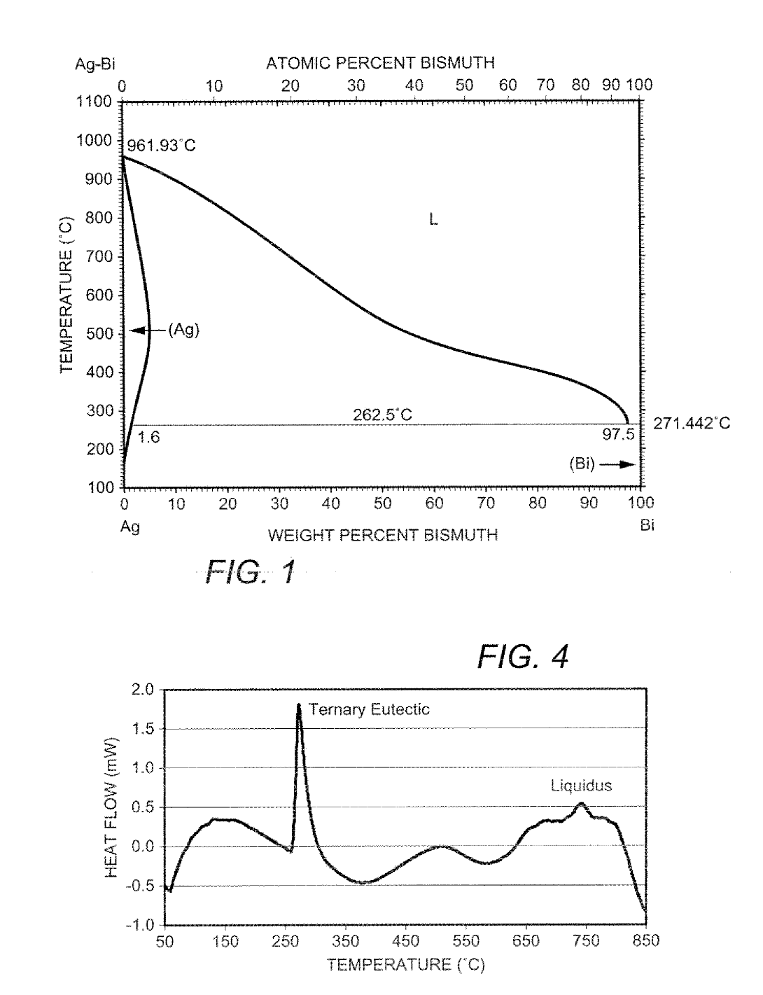

A group of contemplated compositions start with and comprise binary alloys that may be used as solders and that comprise silver in an amount of about 2 weight percent (wt %) to about 18 wt % and bismuth in an amount of about 98 wt % to about 82 wt %. These binary alloys comprise at least one additional metal, as mentioned, in an amount greater than about 5% and less than about 15%. FIG. 1 shows an Ag—Bi phase diagram. The binary alloy on its own is considered to be the “comparison solder composition” that the modified solder compositions contemplated herein are compared with for the purposes of determining the increase in thermal conductivity after addition of the at least one additional material.

Compositions contemplated herein can be prepared by a) providing a charge of appropriately weighed quantities (supra) of the pure metals; b) heating the metals under vacuum or an inert atmosphere (e.g., nitrogen or argon) to between about 900° C.-1200° C. in a refractory or heat resistant vessel (e.g., a graphite crucible) until a liquid solution forms; and c) stirring the metals at that temperature for an amount of time sufficient to ensure complete mixing and melting of both metals. Nickel, zinc, germanium, copper, calcium or combinations thereof may be added to the charge or molten material at dopant quantities of up to about 1000 ppm, and in some embodiments of up to about 500 ppm.

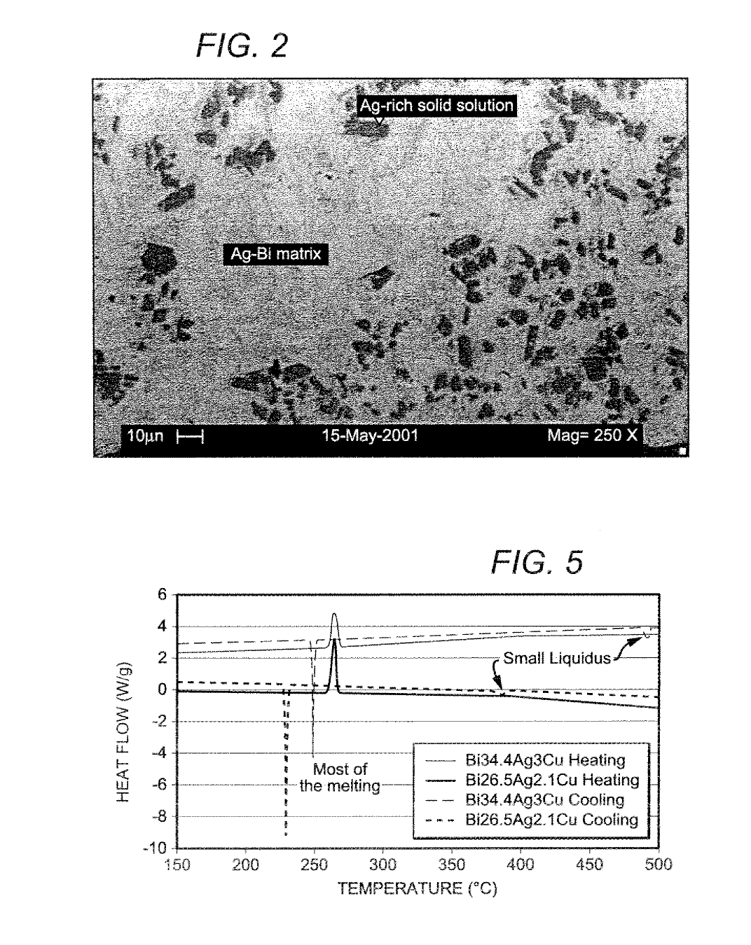

The molten mixture, or melt, is then quickly poured into a mold, allowed to solidify by cooling to ambient temperature, and fabricated into wire by conventional extrusion techniques, which includes heating the billet to approximately 190° C., or into ribbon by a process in which a rectangular slab is first annealed at temperatures between about 225-250° C. and then hot-rolled at the same temperature. Alternatively, a ribbon may be extruded that can subsequently be rolled to thinner dimensions. The melting step may also be carried out under air so long as the slag that forms is removed before pouring the mixture into the mold. FIG. 2 shows an electron micrograph, in which the Ag—Bi alloy appears to form a hypoeutectic alloy wherein the primary constituent (silver) is surrounded by fine eutectic structure. As can be seen from the electron micrograph, there is only negligible mutual solubility in the material, thus resulting in a more ductile material than bismuth metal.

In other embodiments, especially where higher liquidus temperatures are desired, contemplated compositions may include different percentages of alloying materials, such as Ag in the alloy in an amount of about 7 wt % to about 18 wt % and Bi in an amount of about 93 wt % to about 82 wt %. On the other hand, where relatively lower liquidus temperatures are desired, contemplated compositions may include similar materials in different percentages, such as Ag in the alloy in an amount of about 2 wt % to about 7 wt % and Bi in an amount of about 98 wt % to about 93 wt %. Some die attach applications may utilize a composition in which Ag is present in the alloy in an amount of about 5 wt % to about 12 wt % and Bi in an amount of about 95 wt % to about 88 wt %. As previously mentioned, in these modified alloys, at least one additional metal is present in the alloy.

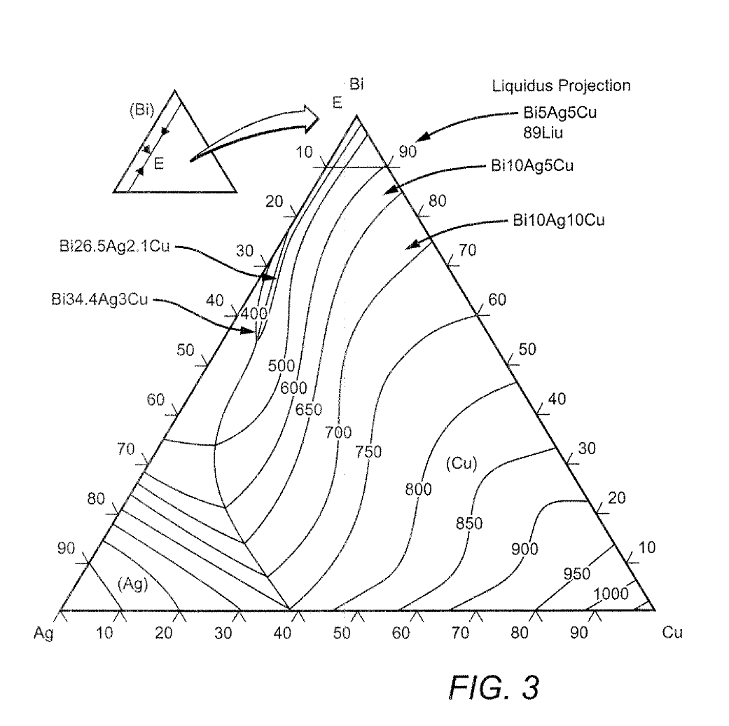

The at least one additional metal should affect the increase of the thermal conductivity without significantly affecting the solidus and liquidus temperature of the alloy. Contemplated additional metals comprise copper, zinc, magnesium, aluminum or a combination thereof. The modified alloys are produced by adding less than about 15% of at least one additional metal, such as those described above. In some embodiments, the modified alloys have less than 10% of at least one additional metal. In yet other embodiments, the modified alloys comprise more than 5% of at least one additional metal. FIG. 3 shows a phase diagram containing silver, bismuth and copper.

In those embodiments where the additional metal comprises zinc, one method of adding it is to simply add it to the bismuth at a temperature of approximately 400° C. In those embodiments where copper is utilized as the additional metal, copper is best added by melting it with silver and then adding the molten silver-copper alloy to the molten bismuth. In both cases, germanium is added after the Bi—Ag—X (where X is the additional metal or metals forming the ternary or higher alloy) alloy has been stirred and cooled to approximately 300° C. to avoid excessive volatilization of germanium via its oxides. Table 1 shows melting and thermal conductivity results for various contemplated solders with at least one additional metal added, as compared with bismuth and antimony individually.

FIG. 4 shows the DTA (differential thermal analysis) curve at 20° C./min for the Bi10Ag10Cu—Ge solder alloy in Table 1. This information shows that the vast majority of the melting occurs at 260-270° C. There may be a small amount of melting around the liquidus temperature of 720° C., but it is not essential for the solder to be completely liquid during application.

FIG. 5 shows the DSC (differential scanning calorimetry) data at 20° C./min for the two new solder alloys (Bi26.5Ag2.1Cu—Ge and Bi34.4Ag3Cu—Ge) shown in Table 1. This information shows that these alloys behave as expected from the phase diagram with most of the melting in the 260-270° C. range and a small peak at a higher temperature. They both also “undercool” significantly which is expected for fairly high purity alloys. DSC is much more sensitive than DTA and also has a much more linear baseline.

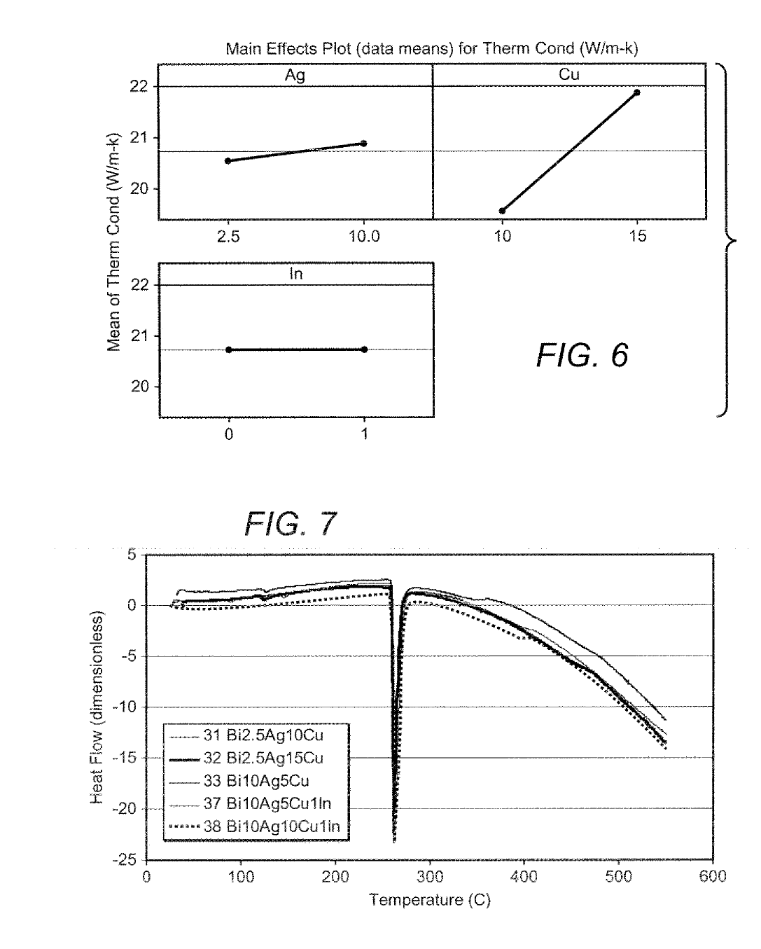

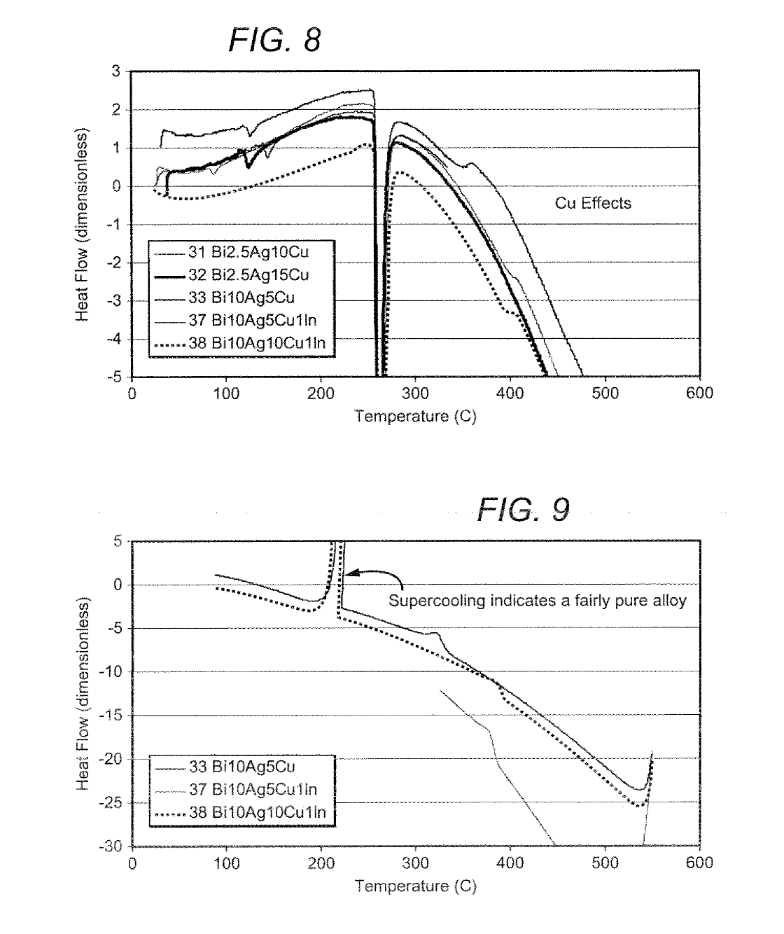

Table 2 shows another group of contemplated solder alloys and their thermal data. FIG. 6 shows the main effects plot for thermal conductivity and FIGS. 7-9 show DTA data for these solder alloys in Table 2.

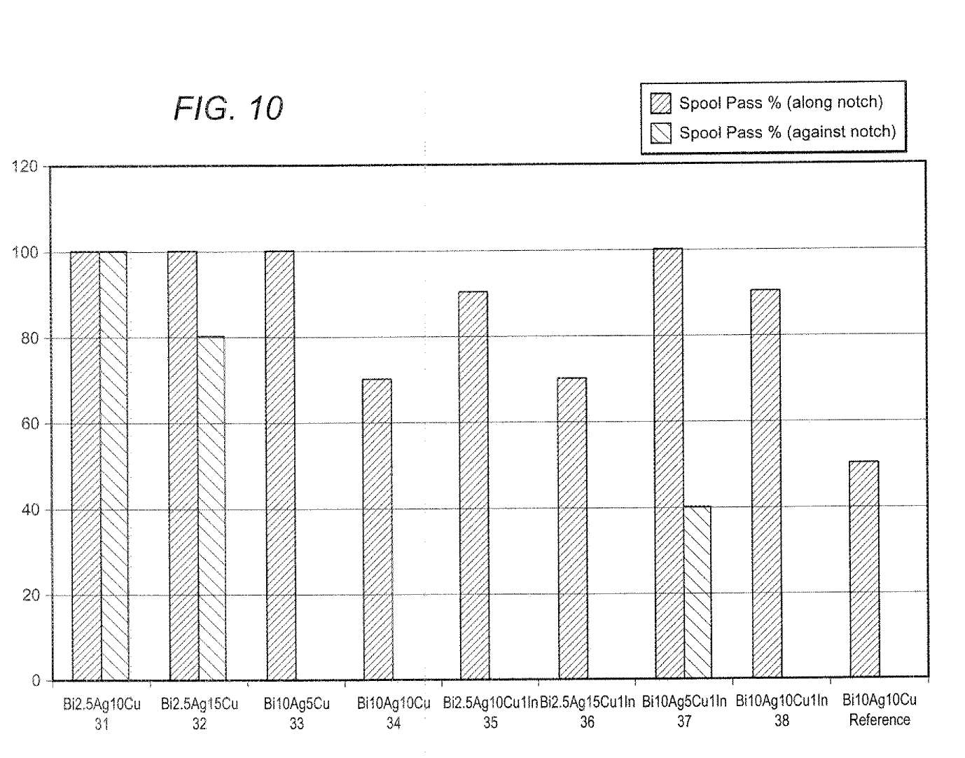

In some embodiments, at least one metal may be added to increase the ductility of the solder composition. There are a couple of other options for increasing ductility, including wire surface coating to arrest cracks and refining the structure of the billets, but neither of these are universal for the application. The addition of the at least one metal can improve wire ductility for the applications contemplated. This additive, along with the optimization of silver and copper as an additional metal, can meet the needs of having a high thermal conductivity in the right melting range, while also being quite ductile. In one embodiment, up to 1 weight percent of indium can be added to the solder composition, along with copper, to produce this quite ductile solder composition. In another embodiment, a contemplated quite ductile solder composition comprises up to 10% silver, up to 15% copper and up to 1% indium with the remaining solder composition comprising bismuth. Table 3 and FIG. 10 show wire ductility results utilizing several solder alloys. In some embodiments, its been discovered that lower silver concentrations and higher copper concentrations give better ductility results. Also, if there is a large concentration of silver in the solder, a small amount of indium can improve ductility of that high-silver alloy.

It should be understood that the solder compositions and materials contemplated herein are substantially lead-free, wherein “substantially” means that the lead present is a contaminant and not considered a dopant or an alloying material.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. As used herein, the term “compound” means a substance with constant composition that can be broken down into elements by chemical processes.

It has been discovered that, among other desirable properties, contemplated compositions may advantageously be utilized as near drop-in replacements for high-lead containing solders in various die attach applications. In some cases, contemplated compositions are lead-free alloys having a solidus of no lower than about 240° C. and a liquidus no higher than about 500° C., and in other cases no higher than about 400° C. Various aspects of the contemplated methods and compositions are disclosed in PCT application PCT/US01/17491 incorporated herein in its entirety.

At this point it should be understood that, unless otherwise indicated, all numbers expressing quantities of ingredients, constituents, reaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

It should be particularly appreciated that these contemplated and novel compositions may be utilized as lead-free solders that are also essentially devoid of Sn as an alloying element, which is a common and predominant component in known lead-free solder. If tin is added to the novel compositions described herein, it is added as a dopant and not for the purposes of alloying.

Consequently, and depending on the concentration/amount of the at least one additional element, it should be recognized that such alloys will have a solidus of no lower than about 230° C., more preferably no lower than about 248° C., and most preferably no lower than about 258° C. and a liquidus of no higher than about 500° C. and in some cases no higher than about 400° C. Especially contemplated uses of such alloys includes die attach applications (e.g., attachment of a semiconductor die to a substrate). Consequently, it is contemplated that an electronic device will comprise a semiconductor die coupled to a surface via a material comprising the composition that includes contemplated ternary (or higher) alloys. With respect to the production of contemplated ternary alloys, the same considerations as outlined above apply. In general, it is contemplated that the third element (or elements) is/are added in appropriate amounts to the binary alloy or binary alloy components.

It should further be appreciated that addition of chemical elements or metals to improve one or more physico-chemical or thermo-mechanical properties can be done in any order so long as all components in the alloy are substantially (i.e. at least 95% of each component) molten, and it is contemplated that the order of addition is not limiting to the inventive subject matter. Similarly, it should be appreciated that while it is contemplated that silver and bismuth are combined prior to the melting step, it is also contemplated that the silver and bismuth may be melted separately, and that the molten silver and molten bismuth are subsequently combined. A further prolonged heating step to a temperature above the melting point of silver may be added to ensure substantially complete melting and mixing of the components. It should be particularly appreciated that when one or more additional elements are included, the solidus of contemplated alloys may decrease. Thus, contemplated alloys with such additional alloys may have a solidus in the range of about 260-255° C., in the range of about 255-250° C., in the range of about 250-245° C., in the range of about 245-235° C., and even lower.

Where additional elements and in some cases dopants are added, it is contemplated that the at least one of the additional elements and/or dopants may be added in any suitable form (e.g., powder, shot, or pieces) in an amount sufficient to provide the desired concentration of the at least one of the additional elements and/or dopants, and the addition of the third element/elements may be prior to, during, or after melting the components for the binary alloy, such as Bi and Ag.

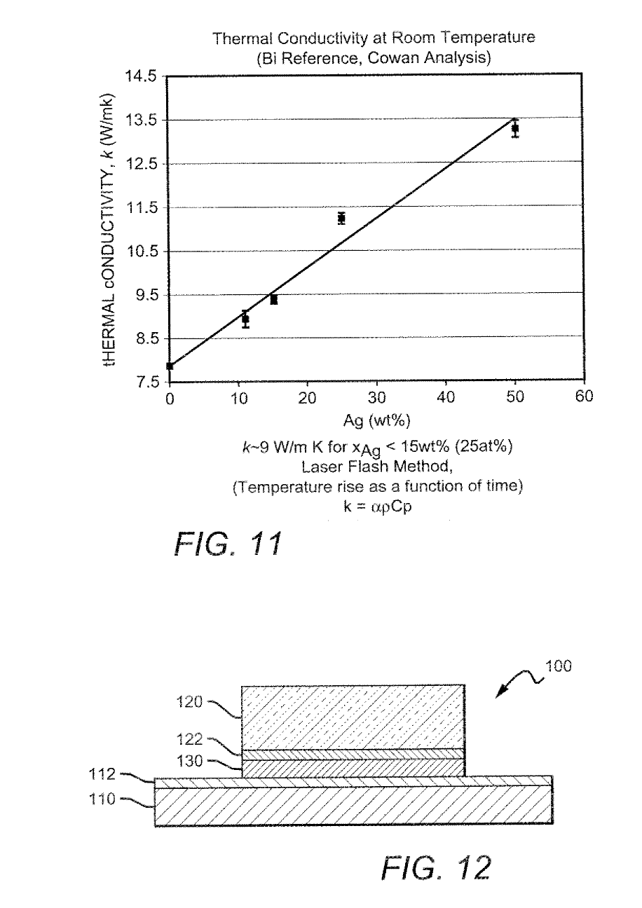

With respect to thermal conductivity of contemplated alloys, it is contemplated that compositions disclosed herein have a conductivity of no less than about 5 W/m K, more preferably of no less than about 9 W/m K, and most preferably of no less than about 15 W/m K. Thermal conductivity analysis for some of the contemplated alloys using a laser flash method indicated thermal conductivity of at least 9 W/m K is depicted in FIG. 11.

Methods of producing these lead-free solder compositions are also disclosed that include providing at least about 2% of silver, providing at least about 60% of bismuth, providing at least one additional metal in an amount that will increase the thermal conductivity of the solder composition over a comparison solder composition consisting of silver and bismuth, blending the bismuth with the at least one additional metal to form a bismuth-metal blend, and blending the bismuth-metal blend with copper to form the solder composition, wherein the at least one additional metal does not significantly modify the solidus temperature and does not shift the liquidus temperature outside of an acceptable liquidus temperature range.

Additional methods of producing a lead-free solder composition having a thermal conductivity include providing at least about 2% of silver, providing at least about 60% of bismuth, providing at least one additional metal in an amount that will increase the thermal conductivity of the solder composition over a comparison solder composition consisting of silver and bismuth, blending the silver with the at least one additional metal to form a silver-metal alloy, and blending the silver-metal alloy with bismuth to form the solder composition, wherein the at least one additional metal does not significantly modify the solidus temperature and does not shift the liquidus temperature outside of an acceptable liquidus temperature range.

Layered materials are also contemplated herein that comprise: a) a surface or substrate; b) an electrical interconnect; c) a modified solder composition, such as those described herein, and d) a semiconductor die or package. Contemplated surfaces may comprise a printed circuit board or a suitable electronic component. Electronic and semiconductor components that comprise solder materials and/or layered materials described herein are also contemplated.

The at least one solder material and/or the at least one additional metal may be provided by any suitable method, including a) buying the at least one solder material and/or the at least one additional metal from a supplier; b) preparing or producing at least some of the at least one solder material and/or the at least one additional metal in house using chemicals provided by another source and/or c) preparing or producing the at least one solder material and/or the at least one additional metal in house using chemicals also produced or provided in house or at the location.

### APPLICATIONS

In the test assemblies and various other die attach applications the solder is generally made as a thin sheet that is placed between the die and the substrate to which it is to be soldered. Subsequent heating will melt the solder and form the joint. Alternatively the substrate can be heated followed by placing the solder on the heated substrate in thin sheet, wire, melted solder, or other form to create a droplet of solder where the semiconductor die is placed to form the joint.

For area array packaging contemplated solders can be placed as a sphere, small preform, paste made from solder powder, or other forms to create the plurality of solder joints generally used for this application. Alternatively, contemplated solders may be used in processes comprising plating from a plating bath, evaporation from solid or liquid form, printing from a nozzle like an ink jet printer, or sputtering to create an array of solder bumps used to create the joints.

In a contemplated method, spheres are placed on pads on a package using either a flux or a solder paste (solder powder in a liquid vehicle) to hold the spheres in place until they are heated to bond to the package. The temperature may either be such that the solder spheres melt or the temperature may be below the melting point of the solder when a solder paste of a lower melting composition is used. The package with the attached solder balls is then aligned with an area array on the substrate using either a flux or solder paste and heated to form the joint.

A contemplated method for attaching a semiconductor die to a package or printed wiring board includes creating solder bumps by printing a solder paste through a mask, evaporating the solder through a mask, or plating the solder on to an array of conductive pads. The bumps or columns created by such techniques can have either a homogeneous composition so that the entire bump or column melts when heated to form the joint or can be inhomogeneous in the direction perpendicular to the semiconductor die surface so that only a portion of the bump or column melts.

It is still further contemplated that a particular shape of contemplated compositions is not critical to the inventive subject matter. However, contemplated compositions are formed into a wire shape, ribbon shape, or a spherical shape (solder bump).

Solder materials, spheres and other related materials described herein may also be used to produce solder pastes, polymer solders and other solder-based formulations and materials, such as those found in the following Honeywell International Inc.'s issued patents and pending patent applications, which are commonly-owned and incorporated herein in their entirety: U.S. patent application Ser. Nos. 09/851,103, 60/357,754, 60/372,525, 60/396,294, and 09/543,628; and PCT Pending Application Ser. No.: PCT/US02/14613, and all related continuations, divisionals, continuation-in-parts and foreign applications. Solder materials, coating compositions and other related materials described herein may also be used as components or to construct electronic-based products, electronic components and semiconductor components. In contemplated embodiments, the alloys disclosed herein may be used to produce BGA spheres, may be utilized in an electronic assembly comprising BGA spheres, such as a bumped or balled die, package or substrate, and may be used as an anode, wire or paste or may also be used in bath form.

Also in contemplated embodiments, the spheres are attached to the package/substrate or die and reflowed in a similar manner as undoped spheres. The dopant slows the consumption rate for the EN coating and results in higher integrity (higher strength) joints.

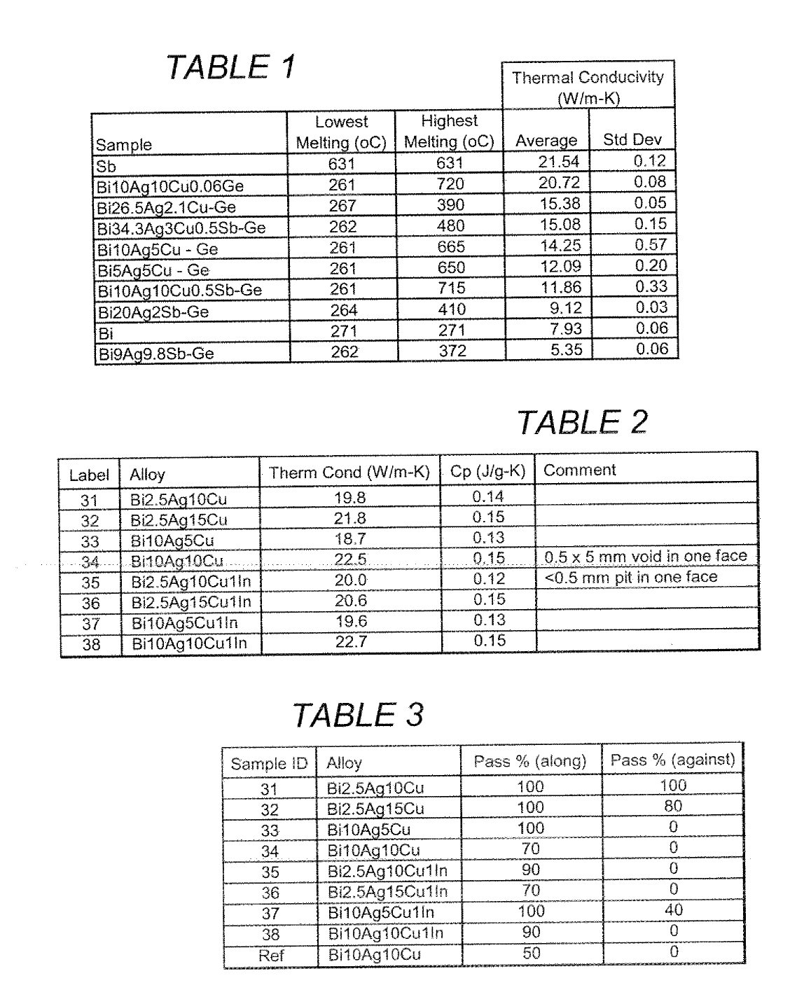

Among various other uses, contemplated compounds (e.g., in wire form) may be used to bond a first material to a second material. For example, contemplated compositions (and materials comprising contemplated compositions) may be utilized in an electronic device to bond a semiconductor die (e.g., silicon, germanium, or gallium arsenide die) to a leadframe as depicted in FIG. 12. Here, the electronic device 100 comprises a leadframe 110 that is metallized with a silver layer 112. A second silver layer 122 is deposited on the semiconductor die 120 (e.g., by backside silver metallization). In addition, some embodiments may include additional metal layers between the leadframe and/or semiconductor die and the silver layer. Typical layers are nickel on the leadframe side and titanium and nickel on the die side, but many other layers are possible. Finally, the silver may be coated or replaced with gold in some applications. The die and the leadframe are coupled to each other via their respective silver layers by contemplated composition 130 (here, e.g., a solder comprising an alloy that includes Ag in an amount of about 2 wt % to about 18 wt % and Bi in an amount of about 98 wt % to about 82 wt %, wherein the alloy has a solidus of no lower than about 262.5° C. and a liquidus of no higher than about 400° C.). In an optimum die attach process, contemplated compositions are heated to about 40° C. above the liquidus of the particular alloy for 15 seconds and preferably no higher than about 430° C. for no more than 30 seconds. The soldering can be carried out under a reducing atmosphere (e.g., hydrogen or forming gas).

In further alternative aspects, it is contemplated that the compounds disclosed herein may be utilized in numerous soldering processes other than die attach applications. In fact, contemplated compositions may be particularly useful in all, or almost all, step solder applications in which a subsequent soldering step is performed at a temperature below the melting temperature of contemplated compositions. Furthermore, contemplated compositions may also be utilized as a solder in applications where high-lead solders need to be replaced with lead-free solders, and solidus temperatures of greater than about 240° C. are desirable, Particularly preferred alternative uses include use of contemplated solders in joining components of a heat exchanger, or as a non-melting standoff sphere or electrical/thermal interconnection.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

As used herein, the term “electronic component” means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. As used herein, the term “battery” means a device that produces usable amounts of electrical power through chemical reactions. Similarly, rechargeable or secondary batteries are devices that store usable amounts of electrical energy through chemical reactions. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are Ics, i.e., integrated circuits in which multiple components and connecting traces are combined to perform multiple or complex functions such as logic.

Solder compositions contemplated herein may also comprise at least one support material and/or at least one stability modification material, such as those described in PCT Application PCT/US03/04374, which is commonly-owned and incorporated herein by reference. The at least one support material is designed to provide a support or matrix for the at least one metal-based material in the solder paste formulation. The at least one support material may comprise at least one rosin material, at least one rheological additive or material, at least one polymeric additive or material and/or at least one solvent or solvent mixture. In some contemplated embodiments, the at least one rosin material may comprise at least one refined gum rosin.

Stability modification materials and compounds, such as humectants, plasticizers and glycerol-based compounds may also positively add to the stability of the solder composition over time during storage and processing and are contemplated as desirable and often times necessary additives to the solder paste formulations of the subject matter presented herein. Also, the addition of dodecanol (lauryl alcohol) and compounds that are related to and/or chemically similar to lauryl alcohol contribute to the positive stability and viscosity results found in contemplated solder paste formulation and are also contemplated as desirable and sometimes necessary additives to contemplated solder paste formulations. Further, the addition or replacement of an amine-based compound, such as diethanolamine, triethanolamine or mixtures thereof may improve the wetting properties of the paste formulation to the point where it is inherently more printable in combination with the stencil apparatus, and therefore, more stable over time and during processing. Dibasic acid compounds, such as a long-chain dibasic acid, can be also used as a stability modification material.

Thus, specific embodiments and applications of modified solder materials utilized as electronic interconnects have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A lead-free solder composition having a thermal conductivity, comprising:
at least about 2% of silver,
at least about 60% of bismuth, and
at least one additional metal in an amount that will increase the thermal conductivity of the solder composition over a comparison solder composition consisting of silver and bismuth, wherein the at least one additional metal does not significantly modify the solidus temperature and does not shift the liquidus temperature outside of an acceptable liquidus temperature range.

2. The lead-free solder composition of claim 1, further comprising germanium, indium or a combination thereof.

3. The lead-free solder composition of claim 1, wherein the at least one additional material comprises copper, zinc, magnesium, aluminum or a combination thereof.

4. The solder composition of claim 1, comprising at least about 7% silver.

5. The solder composition of claim 1, comprising at least about 20% silver.

6. The solder composition of claim 1, comprising at least about 72% bismuth.

7. The solder composition of claim 1, comprising at least about 93% bismuth.

8. The solder composition of claim 1, comprising less than about 15% of the at least one additional metal.

9. The solder composition of claim 8, comprising less than about 10% of the at least one additional metal.

10. The solder composition of claim 9, comprising less than about 5% of the at least one additional metal.

11. The lead-free solder composition of claim 2, wherein the solder composition is Bi10Ag10Cu—Ge.

12. The lead-free solder composition of claim 2, wherein the solder composition comprises less than 1% indium.

13. The lead-free solder composition of claim 12, wherein the at least one additional metal comprises copper.

14. The lead-free solder composition of claim 1, wherein the composition is used to form a solder paste, a polymer solder, a solder-based formulation or a combination thereof.

15. The lead-free solder composition of claim 1, further comprising at least one support material.

16. The lead-free solder composition of claim 15, wherein the at least one support material comprises at least one rosin material, at least one rheological additive or material, at least one polymeric additive or material, at least one solvent or solvent mixture or a combination thereof.

17. A method of producing a lead-free solder composition having a thermal conductivity, comprising:
providing at least about 2% of silver,
providing at least about 60% of bismuth,
providing at least one additional metal in an amount that will increase the thermal conductivity of the solder composition over a comparison solder composition consisting of silver and bismuth,
blending the bismuth with the at least one additional metal to form a bismuth-metal blend, and blending the bismuth-metal blend with copper to form the solder composition, wherein the at least one additional metal does not significantly modify the solidus temperature and does not shift the liquidus temperature outside of an acceptable liquidus temperature range.

18. The method of claim 17, wherein the solder composition comprises at least one additional material comprises copper, zinc, magnesium, aluminum or a combination thereof.

19. The method of claim 17, wherein the at least one additional metal comprises zinc.

20. The method of claim 17, wherein the solder composition further comprising germanium, indium or a combination thereof.

21. The method of claim 17, wherein the solder composition comprises at least about 7% silver.

22. The method of claim 17, wherein the solder composition comprises at least about 20% silver.

23. The method of claim 17, wherein the solder composition comprises at least about 72% bismuth.

24. The method of claim 17, wherein the solder composition comprises at least about 93% bismuth.

25. The method of claim 17, wherein the solder composition comprises less than about 15% of the at least one additional metal.

26. The method of claim 25, wherein the solder composition comprises less than about 10% of the at least one additional metal.

27. The method of claim 26, wherein the solder composition comprises less than about 5% of the at least one additional metal.

28. The method of claim 20, wherein the solder composition comprises less than 1% indium.

29. A method of producing a lead-free solder composition having a thermal conductivity, comprising:
providing at least about 2% of silver,
providing at least about 60% of bismuth,
providing at least one additional metal in an amount that will increase the thermal conductivity of the solder composition over a comparison solder composition consisting of silver and bismuth, blending the silver with the at least one additional metal to form a silver-metal alloy, and blending the silver-metal alloy with bismuth to form the solder composition, wherein the at least one additional metal does not significantly modify the solidus temperature and does not shift the liquidus temperature outside of an acceptable liquidus temperature range.

30. The method of claim 29, wherein the solder composition further comprising germanium, indium or a combination thereof.

31. The method of claim 29, wherein the solder composition comprises at least one additional material comprises copper, magnesium, aluminum or a combination thereof.

32. The method of claim 29, wherein the solder composition comprises at least about 7% silver.

33. The method of claim 29, wherein the solder composition comprises at least about 20% silver.

34. The method of claim 29, wherein the solder composition comprises at least about 72% bismuth.

35. The method of claim 29, wherein the solder composition comprises at least about 93% bismuth.

36. The method of claim 29, wherein the solder composition comprises less than about 15% of the at least one additional metal.

37. The method of claim 36, wherein the solder composition comprises less than about 10% of the at least one additional metal.

38. The method of claim 37, wherein the solder composition comprises less than about 5% of the at least one additional metal.

39. The method of claim 30, wherein the solder composition is Bi10Ag10Cu—Ge.

40. The method of claim 30, wherein the solder composition comprises less than 1% indium.

41. The method of claim 29, wherein the at least one additional metal comprises copper.

42. The method of one of claims 17 or 29, further comprising providing an amount of germanium and blending it with the solder composition once the composition has cooled below 300° C.

43. A layered material, comprising:
a surface or substrate;
an electrical interconnect;
the solder composition of claim 1; and
a semiconductor die or package.

44. The layered material of claim 43, wherein the surface or substrate comprises a printed circuit board, a lead frame or a suitable electronic component.

45. The layered material of claim 43, wherein the solder composition is formed into a wire shape, a ribbon shape, a spherical shape or a combination thereof.
